(19) United States
(12) Patent Application Publication
(10) Pub. No.: US 2008/0238094 A1
(43) Pub. Date: Oct. 2, 2008

(54) Oilfield Threaded Connection

(75) Inventors: Gordon W. Craig, The Woodlands, TX (US); Matthew A. Hegler, Houston, TX (US)

Correspondence Address: JEFFREY E. DALY;GRANT PRIDECO, L.P., 400 N. SAM HOUSTON PARKWAY EAST, SUITE 900, HOUSTON, TX, 77060, US

(73) Assignee: Grant Prideco, L.P.

(21) Appl. No.: 11/692,243

(22) Filed: Mar. 28, 2007

(51) Int. Cl. F16L 15/06; E21B 17/02; F16L 15/04

(52) U.S. Cl. 285/331; 285/332; 285/332.3

(57) ABSTRACT

A threaded connector 10 includes a box connector 12 having internal threads 18 and a pin connector 14 having external threads 26 for mating with the internal threads. An axially opposing end 34 of the box connector includes a projecting ring 36 extending axially opposite the box weld end with respect to the internal threads. The pin connector 14 has an annular slot 40 for receiving the projecting ring 36, with the slot having an inner wall 44, an outer wall 42, and a base surface 46. At least one of the radially outer surface 60 of the pin connector and the radially inner surface 64 of the box connector is a radiused surface.

### FIELD OF THE INVENTION

The present invention relates to an oilfield threaded connection of the type including a box connector welded on the end of a tubular to mate with a pin connector welded on the end of another tubular. More particularly, the present invention relates to a highly loadable threaded connection which is able to reliably withstand high tension, high compression, and high bending.

### BACKGROUND OF THE INVENTION

Various types of threaded connection have been devised for securing to the end of tubulars to thread tubulars together. Oilfield threaded connection commonly includes a box connector having internal threads and a pin connector having external threads, with each connector being secured by welding to a respective tubular. The connectors are then threaded together to join the tubulars together. When subjected to high loading forces, however, these connectors may structurally fail and/or may leak. When high tension loads are applied to a connection, significant bending forces may be created as a result of the difference between the radial spacing of the threaded connectors and the smaller radial spacing of the tubulars. Connectors commonly have a thread pitch diameter that is greater than the diameter of the tubular, and thus create a shift in the load path during extreme tension loading. The tension loading may deform the connection at the outermost ends, thus creating difficulty with the sealing effectiveness.

While various types of oilfield threaded connections are presented with this problem, the problem is enhanced if the size of the connection is enlarged, and is more acute for connections which have an outer box surface and an outer pin surface that is greater than about 18 inches. In most of these applications, the OD of the connection is larger than the OD of the pipe or tubular to which the connector is attached. Large connectors may have an outer diameter of 38 inches or more. The connector outer diameter is thus often significantly larger than the tubular outer diameter. For most of these connectors, the ID of the connector is the same or substantially the same as the ID of the tubular on which the connector is welded. For large diameter tubulars, tension and compressive forces may be 20 million pounds or more. In a response to high tension forces, the ends of the connectors bend outward, which may cause failure of the connection. Substantial bending moments in excess of 15 million pounds are frequently applied to large connections. High bending loads are not uncommon when connections are used in deep water well constructions.

Well drillers, and particularly drillers of offshore wells, continue to move into deeper and more challenging well designs. Connections used on large bore casing should offer dependable mechanical and pressure sealing performance. While the use of O-ring seals has been a standard for internal pressure seals for this type of connection, O-ring seals frequently are only a customer option when creating large diameter connections.

U.S. Pat. No. 3,359,013 discloses a casing joint designed for deep water applications. The tapered end surface on the pin engages the mating surface on the box to resist axial separation of the pin and box. U.S. Pat. No. 3,870,351 discloses a tubular connection with a radiused end on the box which engages a radiused surface on the pin. U.S. Pat. No. 4,707,001 discloses embodiments with a tapered surface on the end of the box which mates with a similar tapered surface on the pin. None of these references solve the problem of providing a highly reliable loadable connection which is able to withstand the high tension, high pressure, and high bending forces discussed above. U.S. Pat. No. 4,770,444 discloses a pipe joint with an end surface on the pin member which engages a tapered end surface on the box member. A radiused surface on the pin member also engages a tapered surface on the box member to form a seal. This connection provides very little resistance to outward bowing of the box connector in response to high tensile forces and/or high bending forces, particularly since the surfaces are preferably spaced apart, and since the radiused and frustoconical surfaces engage before the end surface is engaged. U.S. Pat. No. 4,757,593 discloses another technique for locking connecting members together. U.S. Pat. No. 4,711,471 discloses a technique for cutting locking tabs on a threaded joint to eliminate clocking. U.S. Pat. No. 4,846,508 discloses a tubular connection with a collar for coupling two joints together. Both the joints and the coupling may be provided with hook threads, and multiple thread entries are utilized to reduce rotation prior to complete makeup. U.S. Pat. No. 6,682,107 discloses a preloaded connection with a wedge ring that fits within a radially outer slot in the pin connector to engage a tapered end surface of the box connector.

The disadvantages of the prior art are overcome by the present invention, and an improved threaded connection is hereinafter disclosed suitable for reliably withstanding high loading forces.

### BRIEF SUMMARY OF THE INVENTION

In one embodiment, the threaded connection includes a box connector for welding on the end of a tubular to mate with the pin connector for welding on the end of another tubular. The box connector has internal threads, a box shoulder spaced axially between a weld end for welding to the end of the tubular and the internal threads, and a box outer surface. The pin connector has external threads for mating with the internal threads, a pin weld end for welding to the end of another tubular, a pin end for engaging the box shoulder, and an outer pin surface. An opposing end of the box connector axially opposite the box weld end includes a projecting ring extending axially opposite the box weld end with respect to the internal threads. The opposing end of the pin connector axially opposite the pin weld end has an annular slot for receiving the projecting ring therein. In this embodiment, the annular slot has a radial inner wall, a radial outer wall, and a base surface extending between the inner wall and the outer wall. At least one of the radial outer surface of the pin connector and the engaging radial inner surface of a box connector is a radiused surface, and the other of these surfaces may be a frustoconical surface. In one embodiment, a radially outer wall of the slot is angled with respect to the centerline of the pin connector at from 0 to 15°.

These and further features and advantages of the present invention will become apparent from the following detailed description, wherein reference is made to the figures in the accompanying drawings.

### BRIEF DESCRIPTION OF THE DRAWINGS

FIG. 1 is a cross-sectional view of a suitable threaded connection according to the present invention.

FIG. 2 is an enlarged view of the connection shown in FIG. 1, showing further details with respect to the projecting ring and the receiving slot.

FIG. 3 is an enlarged view of the projecting ring and slot prior to make up.

FIG. 4 illustrates the projecting pin and slot as shown in FIG. 2 when the connection is axially tensioned.

FIG. 5 illustrates a portion of an alternate connection with a different projecting ring and receiving slot.

### DETAILED DESCRIPTION OF THE INVENTION AND THE PREFERRED EMBODIMENT

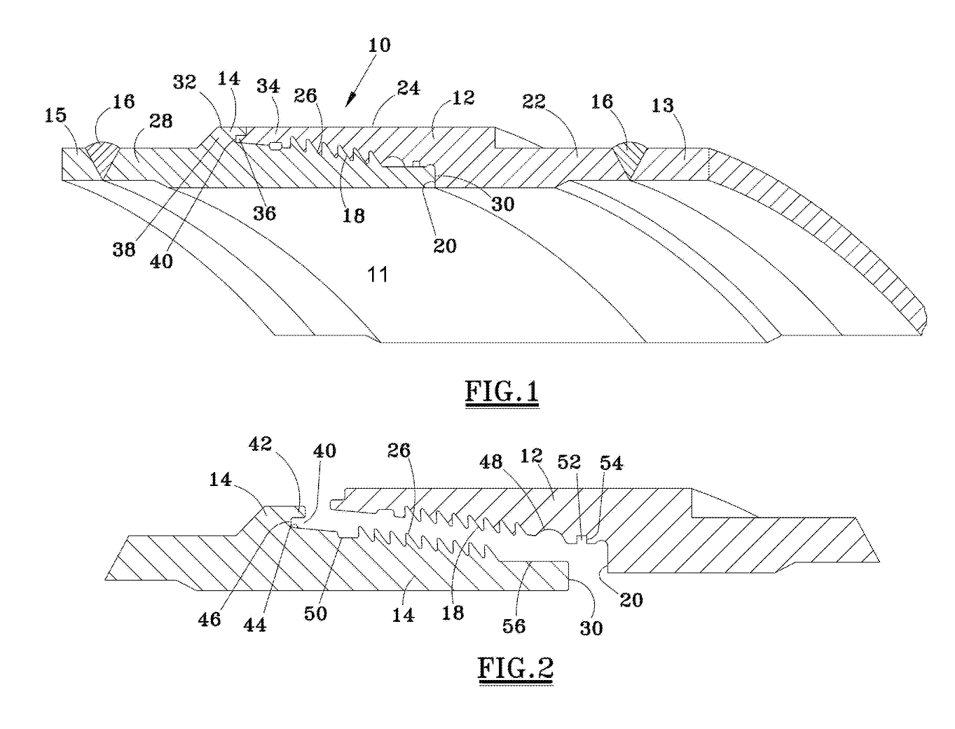

FIG. 1 illustrates one embodiment of a highly loadable threaded connection 10, including a box connector 12 for welding on the end of tubular 13 mated with the pin connector 14 on the end of tubular 15. An end of each connector may be permanently attached to a respective tubular by weld 16. The radially outward or upset portion of each connector is spaced a substantially radial distance outward from an outer surface of the respective tubular. The central bore 11 through each connector approximates the bore of the tubular.

The box connector 12 includes internal threads 18, a box shoulder and an outer box surface 24. The internal threads 18 are spaced between a box end 36 of the box connector 12 and the shoulder 20. The pin connector 14 has external threads 26 for mating with the internal threads 18, a pin weld end 28 for welding to the end of tubular 15, and a pin end shoulder 30 for mating with the box shoulder 20. The pin connector 14 has an outer pin surface 32 which, for this embodiment is substantially equal to the diameter of the outer box surface 24 of the box connector. The shoulders 20, 30 may be substantially perpendicular to the axis of the respective connector, e.g., 15° or less from perpendicular, and may function as the torque engaging shoulders of the connection.

Opposing end 34 of the box connector axially opposite the weld end 22 with respect to the internal threads 18 includes a projecting ring 36 extending axially opposite the box weld end with respect to the internal threads 18. The projecting ring 36 is preferably an annular member which extends axially from the outer surface 24 of the box member in a direction away from the internal threads 18. Opposing end 38 of the pin connector 14 opposite the weld end 28 has an annular slot 40 which receives the projecting ring 36 therein.

FIG. 2 illustrates in greater detail components of the box connector 12 and the pin connector 14 prior to makeup. More particularly, the annular slot 40 is shown with a radially outer wall 42, a radially inner wall 44, and a base surface 46 extending radially between the inner wall 44 and the outer wall 42. Base surface 46 need not be perpendicular to the central axis of the connector, but preferably is angled at less than about 30° relative to perpendicular. FIG. 2 also illustrates that the threads 18, 26 are preferably hook threads, meaning that one of the thread flanks is “negative.” FIG. 2 also illustrates a dope receiving cavity 48 in the box and a similar cavity 50 in the pin, with each of these cavities also serving to reduce high stress concentration locations. An O-ring seal 52 is provided in an annular groove 54 in the box for engaging the frustoconical sealing surface 56 on the pin between the threads 26 and the shoulder 30. The internal pressure seal 52 is preferably an elastomeric seal carried on the box connector.

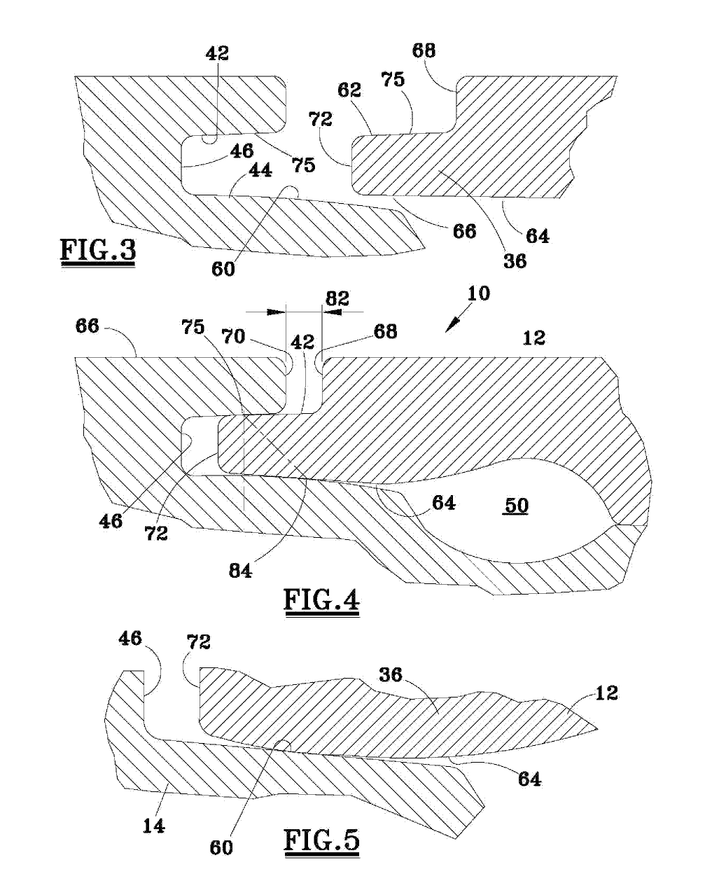

Referring now to FIG. 3, an enlarged cross sectional view of the pin and box prior to makeup illustrates that a radially outer surface 60 on the pin connector 14 slopes into the radially inner wall 44 of the slot. Preferably, at least a portion of surface 60 is a radiused surface, with its center (or centers) radially inward of surface 64. The surfaces 64 and 32 form bases 66. The radially inner wall 44 of the slot may be a tapered (frustoconical) surface. In one option, the outer slot wall 42 may be a cylindrical surface, and the outer surface 62 of the projecting ring 36 may be a frustoconical surface. Alternatively, the slot wall 42 may be frustoconical, and the surface 62 may be cylindrical. The radially outer surface 60 of the pin connector may thus mate with the radially inner surface 64 of the box connector. One surface may be a frustoconical surface, and the mating surface may be a radiused surface. During the compressive loading, the outer box shoulder 68, which may be substantially perpendicular to the axis of the tubular, may engage the pin outer shoulder 70, and the end surface 72 of the projecting ring 36 may engage the base surface 46 of the slot 40. These surfaces normally do not engage under high tension or bending loading.

It is a preferred feature of the invention that one of the surfaces 60, 64 be a radiused surface, and the other of the surfaces which mate with this surface is a frustoconical surface. A radiused surface has an axial protrusion which mates well with a frustoconical surface during high force applications, and may also form a highly reliable metal-to-metal seal. At least one of the surfaces 42 and 62 may also be frustoconical, and the other surface may be either frustoconical or may be cylindrical. Preferably, surface 42, 62 are arranged so that as the pin and box engage, the surfaces 60, 64 are brought into tighter engagement. In another embodiment, each of the radially outer surface 60 of the pin connector and the radially inner wall 64 of the box connector may be a radiused surface.

The radially outer wall 62 of a slot may be a frustoconical surface which is angled with respect to a centerline of a pin connector at from 0° to 15°. This provides a desired high camming force to press the projecting ring 36 radially inward during makeup of the connection. In a preferred embodiment, the radial thickness of a projecting ring 36 approximates the radial thickness between the outer wall 42 of the annular slot and the outer pin surface 32. As discussed above, the base surface 46 of a slot and the pin connector end surface 72 may engage during axial compression of the threaded connection.

An axial centerline of metal-to-metal interference between the radially outer surface 60 of the pin connector and the radially inner surface 64 of the box connector is axially spaced less than 30° from the midpoint of engagement, designated as point 75 as shown in FIG. 3, between engagement of a radially outer surface 62 of the projecting ring 36 and a radially outer wall 42 of the slot. This interference is thus spaced axially closely adjacent the interference of the pin and box, so that high loading forces may be reliably transmitted through the connection. In another embodiment, an axial spacing between an axial centerline of the midpoint of interference between the radially outer surface of the pin connector and a radially inner surface of the box connector, e.g., point 75 as shown in FIG. 3, is less than about 3 times an axial depth of the slot.

As discussed below, FIG. 4 illustrates a portion of the connection when tensioned. FIG. 4 also illustrates the angular spacing between axial midpoint 75 for the engaging surfaces 42 and 62, and the axial midpoint 84 between the engaging surfaces 60, 64. FIG. 4 thus illustrates that point 84 is spaced angularly from point 70 by less than 30°, thereby resulting in high loading forces being transmitted between the pin and box member at point 84.

During axial expansion of the connection or during high bending forces applied to the connection, the outer surface 60 of the pin connector, which may be a radiused surface, continues to seal with the frustoconical surface 64 on the box member. A particular feature is that the radiused surface is provided on the pin member, so that the location of the interference between these surfaces does not appreciably change, i.e., the frustoconical surface moves axially with respect to the radiused surface, but the location of the seal or interference between the surfaces does not appreciably change. Even though the projecting ring may thus move axially with respect to the slot during use of the connection, conventional movement during high tension and/or high bending would still retain the projecting ring 36 within the slot, thereby preventing outward bowing of the end of the box connector opposite the weld end. In another embodiment, both surfaces 60 and 64 may be radiused surfaces.

In a preferred embodiment, the interference between the inner surface 64 on the box member and the outer surface 60 on the pin member may also be sufficient to form the highly reliable metal-to-metal seal between these surfaces, so that fluid exterior of the connection is sealed from the threads. In other cases, a fairly low integrity seal may be provided, e.g., the interference between the surfaces 64 and 60 may be such that water or other liquids are normally prevented from traveling inward and engaging the threads, but limited migration of gases from the exterior to the threads 18, 26 may be permissible.

FIG. 1 illustrates an exemplary position of the projecting pin 36 with respect to the slot prior to high loading of the connection. As shown in FIG. 4, the connection is axially tensioned, so that the box outer shoulder 68 is axially separated from the pin outer shoulder 70 by an axial spacing 82 which is increased compared to the spacing with no load being applied to the connection. Similarly, the base 46 of the slot is separated from the pin and surface 72 by an increased axial spacing compared to when the connection is not loaded. In the FIG. 4 embodiment, the axial centerline of contact 75 between the surfaces 42 and 62 has also moved axially away from the base surface 46 of the slot, and the midpoint 84 between the interfering surfaces 64 and 60 has also moved slightly axially away from the base 46 of the slot. The design nevertheless provides for high loading since the projecting ring 36 is still retained within the slot and provides a high force to resist outward expansion of the box end while transmitting high sealing forces between surface 60 and 64.

For the embodiment in FIG. 5, surface 64 which is the radially inner surface on the box member 12 is the radiused surface, and the mating surface 60 which is the external surface on the pin member 14 is the frustoconical surface. The embodiment as shown in FIG. 5 may be desirable for certain applications. An advantage obtained by providing the radiused surface on the pin member is that the axial location of the metal-to-metal seal between the surfaces 60 and 64 will be more precisely known, since the “high point” on this surface is fixed with respect to the pin. For the FIG. 5 embodiment, the high point is on the radiused surface 64 on the box member, which moves axially as the box member is moved to engage the pin. Accordingly, the center axial location of the metal-to-metal interference and the seal between these surfaces is less certain, which affects the design and reliability of the seal.

The connection of the present invention is particularly well suited for forming a large diameter threaded connections between a pin and box, i.e., connections in which the outer surface of each of the box connector and pin connector is greater than 18 inches. As is apparent in FIGS. 1 and 2, each of the outer box surface and outer pin surface are radially outward of an outer surface of the respective tubular.

A preferred torque shoulder connection according to the present invention includes a torque shoulder at an angle slightly less than 90° from vertical, i.e., a slight positive angle, or an angle perpendicular to the central axis of the connection. This angle may be used in conjunction with the negative load flank angle on the threads to reduce thread compound application sensitivity. While a preferred embodiment for such a connection is a torque shoulder connection with stepped threads and the shoulder between the steps of the threads, the concepts may also be applied to both integral connectors and other connectors with a torque shoulder. In alternate embodiments, the desired relationship between load flank threads and the torque shoulder can be obtained by using positive load flanks on the threads and a negative torque shoulder angle. For this application, the torque shoulder could thus have a negative angle of, e.g., 5°, and the load flanks on the threads could have a positive angle of, e.g., 6°.

Although specific embodiments of the invention have been described herein in some detail, this has been done solely for the purposes of explaining the various aspects of the invention, and is not intended to limit the scope of the invention as defined in the claims which follow. Those skilled in the art will understand that the embodiment shown and described is exemplary, and various other substitutions, alterations and modifications, including but not limited to those design alternatives specifically discussed herein, may be made in the practice of the invention without departing from its scope. Whereas the present invention has been described in particular relation to the drawings attached hereto, it should be understood that other and further modifications apart from those shown or suggested herein, may be made within the scope and spirit of the present invention.

What is claimed is:

1. A loadable threaded connection including a box connector for welding on an end of a tubular to mate with a pin connector for welding on an end of another tubular, comprising:
the box connector having internal threads, a box shoulder spaced axially between a box attachment end for attaching to the end of the tubular and the internal threads, and an outer box surface;
a pin connector having external threads for mating with the internal threads, a pin attachment end for attaching to the end of the another tubular, a pin end for engaging the box shoulder, and an outer pin surface;
an opposing end of the box connector axially opposite the box attachment end including a projecting ring extending axially opposite the box attachment end with respect to the internal threads;
an opposing end of the pin connector axially opposite the pin attachment end having an annular slot for receiving the projecting ring therein, the annular slot having a radially outer wall, a radially inner wall and a base surface extending between the inner wall and the outer wall;
one of a radially outer surface of the pin connector axially between the slot base surface and the external threads on the pin connector and a radially inner surface of the box connector between the internal threads on the box connector and an end of the projecting ring being a radiused surface.

2. A threaded connection as defined in claim 1, further comprising:
the other of the radially outer surface of the pin connector and the radially inner surface of the box connector being a frustoconical surface for engagement with the radiused surface.

3. The threaded connection as defined in claim 1, further comprising:
the radially outer surface of the pin connector being the radiused surface;
the radially inner surface of the box connector being a frustoconical surface tapered radially inward in a direction away from the external threads; and
at least one of a radially outer surface of the projecting ring and the radially outer wall of the annular slot being tapered to force the projecting ring toward the pin connector as the connection is made up.

4. The threaded connection as defined in claim 3, wherein sliding engagement of the radially outer wall of the slot and the radially outer surface of the projecting ring forces the projecting ring radially inward as the projecting ring moves axially toward the base of the slot.

5. The threaded connection as defined in claim 1, wherein each of the radially outer surface of the pin connector and the radially inner surface of the box connector is a radiused surface.

6. The threaded connection as defined in claim 1, further comprising:
an internal pressure seal axially opposite the projecting ring with respect to the internal threads for sealing between the box connector and the pin connector to seal internal pressure within the connection.

7. The threaded connection as defined in claim 6, wherein the internal pressure seal is an elastomeric seal carried on the box connector.

8. The threaded connection as defined in claim 1, wherein the radially outer wall of the slot is angled with respect to a centerline of the pin connector at from 0 to 15°.

9. The threaded connection as defined in claim 1, wherein an axial centerline of metal-to-metal interference between the radially outer surface of the pin connector and the radially inner surface of the box connector is axially spaced at less than 30° from an axial centerline of metal-to-metal interference between a radially outer surface of the projecting ring and the radially outer wall of the slot.

10. A threaded connection as defined in claim 1, wherein an axial spacing between an axial centerline of a metal-to-metal interference between the radially outer surface of the pin connector and the radially inner surface of the box connector and an axial centerline of metal-to-metal interference between a radially outer surface of the projecting ring and the radially outer wall of the slot is less than 3 times an axial depth of the slot.

11. The threaded connection as defined in claim 1, wherein a radial thickness of the projecting ring approximates a radial thickness between the radially outer wall of the annular slot and the outer pin surface.

12. The threaded connection as defined in claim 1, wherein the internal threads and the external threads are each hook threads.

13. The threaded connection as defined in claim 1, wherein each of the outer surface of the box connector and the outer surface of the pin connector is greater than 18 inches.

14. The threaded connection as defined in claim 1, wherein each of the outer box surface and the outer pin surface are radially outward of an outer surface of each of the tubular and the another tubular.

15. A threaded connection including a box connector for welding on an end of a tubular to mate with a pin connector for welding on an end of another tubular, comprising:
the box connector having internal threads, a box shoulder spaced axially between a bit weld end for welding to the end of the tubular and the internal threads, and an outer box surface;
a pin connector having external threads for mating with the internal pin threads, a weld end for welding to the end of the another tubular, a pin end for engaging the box shoulder, and an outer pin surface;
an opposing end of the box connector axially opposite the box weld end including a projecting ring extending axially opposite the box weld end with respect to the internal threads;
an opposing end of the pin connector axially opposite the box weld end having an annular slot for receiving the projecting ring therein;
one of a radially outer surface of the pin connector axially between the slot and the external threads on the pin connector and a radially inner surface of the box connector between the internal threads on the box connector and the projecting ring being a radiused surface;
the other of the radially outer surface of the pin connector and the radially inner surface of the box connector being a frustoconical surface for engagement with the radiused surface; and
at least one of a radially outer surface of the projecting ring and the radially outer wall of the annular slot being tapered to force the projecting ring toward the pin connector as the connection is made up.

16. The threaded connector as defined in claim 15, further comprising:
the radially inner surface of the box connector being the frustoconical surface which is tapered radially inward in a direction away from the external threads; and
a radially outer wall of the projecting ring being tapered radially inward in a direction axially away from the internal threads.

17. A threaded connection as defined in claim 15, wherein a radial thickness of the projecting ring approximates a radial thickness between an outer surface of the annular slot and the outer pin surface.

18. The threaded connection as defined in claim 15, wherein a radially outer wall of the slot is angled with respect to a centerline of the pin connector at from 0 to 15°.

19. The threaded connection as defined in claim 15, wherein an axial centerline of metal-to-metal interference between the radially outer surface of the pin connector and the radially inner surface of the box connector is axially spaced at less than 30° from an axial centerline of metal-to-metal interference between a radially outer surface of the projecting ring and the radially outer wall of the slot.

20. A threaded connection as defined in claim 15, wherein an axial spacing between an axial centerline of a metal-to-metal interference between the radially outer surface of the pin connector and the radially inner surface of the box connector and an axial centerline of metal-to-metal interference between a radially outer surface of the projecting ring and the radially outer wall of the slot is less than 3 times an axial depth of the slot.

21. The threaded connection as defined in claim 15, wherein each of the outer surface of the box connector and the outer surface of the pin connector is greater than 18 inches.

22. The threaded connection as defined in claim 15, wherein the internal threads and the external threads are each hook threads.

23. The threaded connection as defined in claim 15, further comprising:
an internal pressure seal axially opposite the projecting ring with respect to the internal threads for sealing between the connector and the pin connector to seal internal pressure within the connection.

24. A threaded connection including a box connector for welding on an end of a tubular to mate with a pin connector for welding on an end of another tubular, comprising:
the box connector having internal threads, a box shoulder spaced axially between a box weld end for welding to the end of the tubular and the internal threads, and an outer box surface;
a pin connector having external threads for mating with the internal threads, a pin weld end for welding to the end of the another tubular, a pin end for engaging the box shoulder, and an outer pin surface;
an opposing end of the box connector axially opposite the box weld end including a projecting ring extending axially opposite the box weld end with respect to the internal threads;
an opposing end of the pin connector axially opposite the pin weld end having an annular slot for receiving the projecting ring therein;
a radially outer surface of the pin connector axially between the external threads and a base of the slot being a radiused surface;
a radially inner surface of the box connector being a frustoconical surface tapered radially inward in a direction axially away from the internal threads for sealing engagement with the radiused surface; and
at least one of a radially outer surface of the projecting ring and the radially outer wall of the annular slot being tapered to force the projecting ring toward the pin connector as the connection is made up.

25. The threaded connection as defined in claim 24, wherein sliding engagement of the radially outer wall of the slot and the radially outer surface of the projecting ring forces the projecting ring radially inward as the projecting ring moves axially toward a base of the slot.

26. The threaded connection as defined in claim 24, wherein the internal threads and the external threads are each hook threads, and each of the outer box surface and the outer pin surface are radially outward of an outer surface of both the tubular and the another tubular.

27. The threaded connection as defined in claim 24, wherein an axial centerline of metal-to-metal interference between the radially outer surface of the pin connector and the radially inner surface of the box connector is axially spaced at less than 30° from an axial centerline of metal-to-metal interference between a radially outer surface of the projecting ring and the radially outer wall of the slot.

28. A threaded connection as defined in claim 24, wherein an axial spacing between an axial centerline of a metal-to-metal interference between the radially outer surface of the pin connector and the radially inner surface of the box connector and an axial centerline of metal-to-metal interference between a radially outer surface of the projecting ring and the radially outer wall of the slot is less than 3 times an axial depth of the slot.

29. The threaded connection as defined in claim 24, wherein a radial thickness of the projecting ring approximates a radial thickness between the radially outer wall of the annular slot and the outer pin surface.
